(19) United States
(12) Patent Application Publication
(10) Pub. No.: US 2026/0011837 A1
(43) Pub. Date: Jan. 8, 2026

(54) BATTERY PACK AND DEVICE CASE

(71) Applicant: TOYOTA JIDOSHA KABUSHIKI KAISHA, Toyota-shi (JP)

(72) Inventor: Isao TAKAHASHI, Toyota-shi (JP)

(73) Assignee: TOYOTA JIDOSHA KABUSHIKI KAISHA, Toyota-shi (JP)

(21) Appl. No.: 19/039,023

(22) Filed: Jan. 28, 2025

(30) Foreign Application Priority Data
Jul. 2, 2024 (JP) 2024-106660

(51) Int. Cl. H01M 50/24; H01M 50/249; H01M 50/262; H01M 50/271

(52) U.S. Cl. CPC H01M 50/24; H01M 50/249; H01M 50/262; H01M 50/271; H01M 2220/20

(57) ABSTRACT

A battery pack comprising a battery case containing a battery and a device case attached to an upper portion of the battery case and accommodating an electric device, wherein the device case comprises a case body and a cover, wherein the case body is provided with a connector connected to the electric device on a rear wall, and a height of a front wall facing the rear wall is lower than a height of the rear wall.

### CROSS-REFERENCE TO RELATED APPLICATION

This application claims priority to Japanese Patent Application No. 2024-106660 filed on Jul. 2, 2024. The disclosure of the above-identified application, including the specification, drawings, and claims, is incorporated by reference herein in its entirety.

### BACKGROUND

### 1. Technical Field

The present disclosure relates to a battery pack to which a device case for housing an electric device is attached, and a structure of the device case.

### 2. Description of Related Art

An auxiliary device for a battery of a battery electric vehicle is often housed inside a battery pack. For example, Japanese Unexamined Patent Application Publication No. 2012-190644 (JP 2012-190644 A) discloses a battery pack that houses a junction box.

### SUMMARY

In recent years, a large-capacity battery is required in order to increase the cruising distance of a battery electric vehicle. In order to increase the storage volume for the battery, an auxiliary device for the battery may be mounted on a device case on the upper portion of a battery case. In this case, downsizing of the device case is required in order to avoid interference between the battery pack and the body or the like.

In view of the above, an object of the present disclosure is to downsize a battery pack in which a device case is attached to an upper portion thereof.

A battery pack of the present disclosure includes:
a battery case that houses a battery; and
a device case that is attached to an upper portion of the battery case and houses an electric device for the battery.

The device case includes a case body that houses a lower portion of the electric device, and a cover that is connected to an upper end of the case body and covers an upper portion of the electric device.

A connector connected to the electric device is provided on a first wall of the case body.

A height of a second wall of the case body that faces the first wall is smaller than a height of the first wall.

The device case is manufactured by a manufacturing method such as die casting or sheet metal pressing that requires draft for a product. Therefore, the outward projection length increases as the heights of the first and second walls of the device case increase due to the draft. By reducing the height of the second wall without the connector, it is possible to reduce the outward projection length of the second wall, and therefore downsize the device case. Accordingly, it is possible to downsize the battery pack and suppress interference with the body or the like.

In the battery pack of the present disclosure,
a fastening surface between the upper end of the case body and a lower end of the cover may be inclined with respect to a bottom surface of the case body to decrease in height from the first wall toward the second wall.

Accordingly, the case body including the first wall and the second wall having different heights and the cover can be easily sealed and fastened.

In the battery pack of the present disclosure,
the upper end of the case body and the lower end of the cover may be fastened by a first fastening member passing through the fastening surface, and a first seal line for sealing between the upper end of the case body and the lower end of the cover may be provided on an inner periphery of the first fastening member.

The case body may be fastened to a ceiling plate of the battery case by a second fastening member, and a second seal line for sealing between the bottom surface of the case body and the ceiling plate of the battery case may be provided on an outer periphery of the second fastening member.

By providing the first seal line only on the inner side of the first fastening member, the assembling of the cover is facilitated, and the maintainability of the device case can be improved. By providing the second seal line on the outer periphery of the second fastening member, it is possible to prevent water from entering the battery case even when the device case is attached to the upper portion of the battery case.

A device case of the present disclosure is a device case that houses an electric device. The device case includes:
a case body that houses a lower portion of the electric device; and
a cover that is connected to an upper end of the case body and covers an upper portion of the electric device.

A connector connected to the electric device is provided on a first wall of the case body.

A height of a second wall of the case body that faces the first wall is smaller than a height of the first wall.

By reducing the height of the second wall without the connector, it is possible to reduce the outward projection length of the second wall, and therefore downsize the device case.

In the device case of the present disclosure,
a fastening surface between the upper end of the case body and a lower end of the cover may be inclined with respect to a bottom surface of the case body to decrease in height from the first wall toward the second wall.

The upper end of the case body and the lower end of the cover may be fastened by a fastening member passing through the fastening surface.

A seal line for sealing between the upper end of the case body and the lower end of the cover may be provided on an inner periphery of the fastening member.

Accordingly, the case body including the first wall and the second wall having different heights and the cover can be easily sealed and fastened. By providing the seal line only on the inner side of the fastening member, the assembling of the cover is facilitated, and the maintainability of the device case can be improved.

According to the present disclosure, it is possible to downsize the battery pack in which the device case is attached to the upper portion thereof.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery pack according to an embodiment;

FIG. 2 is an elevation cross-sectional view of the battery pack according to the embodiment, which is a II-II cross-section shown in FIG. 1;

FIG. 3 is a cross-sectional elevation view of another embodiment of a battery pack; and

FIG. 4 is an elevational cross-sectional view of a comparable battery pack.

### DETAILED DESCRIPTION OF EMBODIMENTS

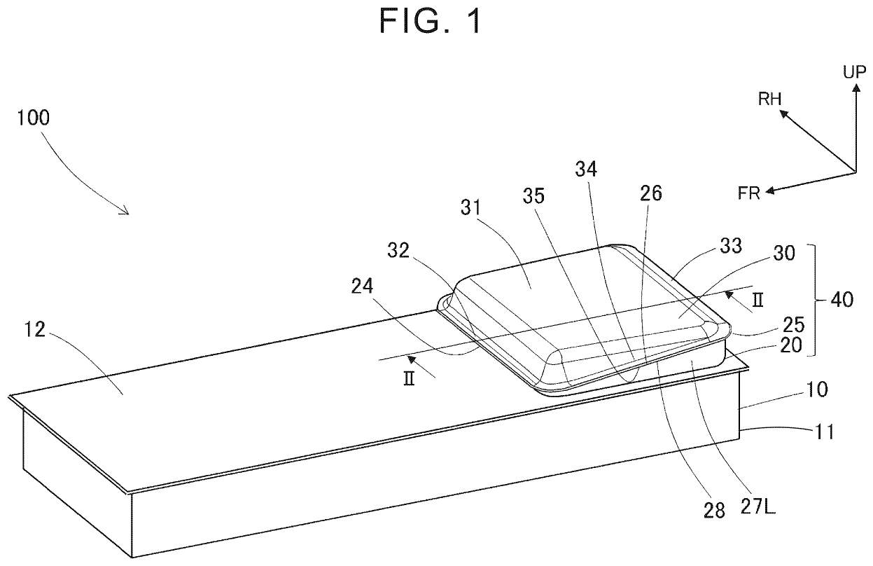

Hereinafter, a battery pack 100 according to an embodiment will be described with reference to the drawings. As illustrated in FIG. 1, the battery pack 100 includes a battery case 10 and a device case 40. Note that FR, UP, RH shown in the drawings indicate the front side, the upper side, and the right side of the battery pack 100, respectively. In addition, the opposite directions of FR, UP, RH indicate the rear side, the lower side, and the left side. Hereinafter, in the case of simply describing the front-rear direction, the left-right direction, and the up-down direction, the front-rear direction, the left-right direction, and the up-down direction of the battery pack 100 will be described unless otherwise specified. The battery pack 100 is mounted on the vehicle such that the front side, the upper side, and the right side are the front side, the upper side, and the right side of the vehicle.

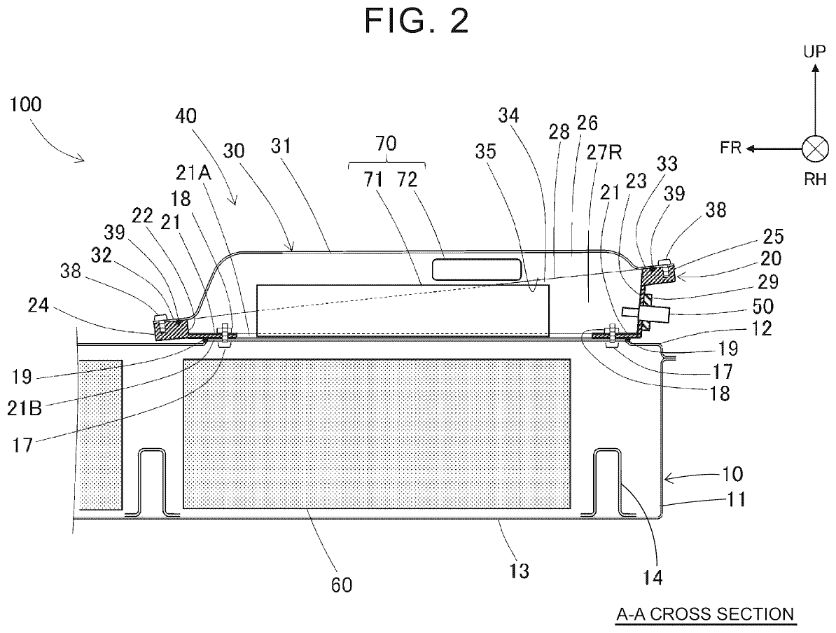

As shown in FIG. 2, the battery case 10 includes a lower case 11 and an upper cover 12. The lower case 11 is a rectangular open box-shaped member having an open upper portion. A plurality of cross members 14 extending in the left-right direction are provided on the bottom plate 13 of the lower case 11. A plurality of batteries 60 are accommodated in the lower case 11. The upper cover 12 is a ceiling plate that covers an open upper portion of the lower case 11. An electric device 70 for a battery is mounted on an upper surface of the upper cover 12.

The electric device 70 includes a junction box 71 and an ECU 72. The junction box 71 is fixed to the upper surface of the upper cover 12. ECU 72 is mounted on the junction box 71.

The device case 40 includes a case body 20 and a cover 30. The case body 20 accommodates a lower portion of the electric device 70. As shown in FIG. 2, the case body 20 is a square open box-shaped member including a bottom plate 21, a front wall 22, a rear wall 23, and left and right side wall 27L, 27R, the upper portion of which is open. A square opening 21A through which the junction box 71 passes is provided in the center of the bottom plate 21. Here, the rear wall 23 constitutes a first wall and the front wall 22 constitutes a second wall.

A connector base 29 is attached to the outer surface of the rear wall 23. A connector 50 connected to the junction box 71 is attached to the connector base 29. The height of the upper end of the front wall 22 is lower than the height of the upper end of the rear wall 23. Further, the upper ends of the left and right side walls 27L, 27R are inclined with respect to the bottom surface 21B of the bottom plate 21 so as to be lower from the rear wall 23 toward the front wall 22. The front wall 22 is provided with a front flange 24 protruding obliquely downward toward the front. Further, the rear wall 23 is provided with a rear flange 25 protruding obliquely upward toward the rear. Further, as shown in FIG. 1, the upper ends of the left and right side wall 27L, 27R are provided with lateral flanges 28.

The upper surface of the front flange 24, the upper surface of the rear flange 25, and the upper surfaces of the left and right side flanges 28 constitute a fastening surface 26 of the case body 20 to the cover 30.

The case body 20 is made of aluminum die cast, and the front wall 22, the rear wall 23, and the left and right side wall 27L, 27R are provided with draft gradients whose upper ends are inclined outward.

The cover 30 includes a main body 31, a front flange 32, a rear flange 33, and left and right side flanges 34. The main body 31 is a rectangular open box-shaped folded plate member with a lower portion opened. The lower surface of the front flange 32, the lower surface of the rear flange 33, and the lower surfaces of the left and right side flanges 34 are inclined surfaces inclined so as to be lower from the rear flange 33 toward the front flange 32. This inclined surface forms a fastening surface 35 of the cover 30 with the case body 20. The cover 30 is formed of a sheet metal brace, and a draft angle in which the lower end is inclined toward the outside is provided on the wall surface of the main body 31.

The front flange 32 of the cover 30, the rear flange 33, and the left and right side flanges 34 are fastened to the front flange 24, the rear flange 25, and the left and right side flanges 28 of the case body 20 by bolts 38 passing through the fastening surfaces 26 and 35. The bolt 38 constitutes the first fastening member. A first seal line 39 for sealing between the fastening surface 26 of the case body 20 and the fastening surface 35 of the cover 30 is provided on the inner periphery of the bolt 38. The first seal line 39 may be formed of, for example, an adhesive, a sealer, or the like, or may be formed of a rubber packing, an O-ring, or the like.

The bottom plate 21 of the case body 20 is fastened to the upper cover 12 of the battery case 10 by a bolt 17 and a nut 18. The bolt 17 passes through the upper cover 12 and the bottom plate 21 to fasten the bottom plate 21 and the upper cover 12. The bolt 17 and the nut 18 constitute a second fastening member. A second seal line 19 for sealing between the bottom surface 21B of the case body 20 and the upper cover 12 is provided on the outer periphery of the bolt 17 and the nut 18. Like the first seal line 39, the second seal line 19 may be formed of an adhesive, a sealer, or the like, or may be formed of a rubber packing, an O-ring, or the like.

In the battery pack 100 configured as described above, by lowering the height of the front wall 22 where the connector 50 is not provided, the protruding length of the front wall 22 having a draft angle to the outside can be shortened, and the device case 40 can be miniaturized. Accordingly, the battery pack 100 can be miniaturized, and interference with a body or the like can be suppressed.

In the battery pack 100, the upper surface of the front flange 24 of the case body 20, the upper surface of the rear flange 25, and the upper surfaces of the left and right side flanges 28 constitute a fastening surface 26 inclined so as to be lower from the rear flange 25 toward the front flange 24. Further, the lower surface of the front flange 32 of the cover 30, the lower surface of the rear flange 33, and the lower surfaces of the left and right side flanges 34 constitute a fastening surface 35 inclined so as to be lower from the rear flange 33 toward the front flange 32. Since the fastening surfaces 26 and 35 are fastened by the bolts 38, the case body 20 including the front wall 22 and the rear wall 23 having different heights and the cover 30 can be easily fastened.

Further, in the battery pack 100, a first seal line 39 for sealing between the fastening surface 26 of the case body 20 and the fastening surface 35 of the cover 30 is provided only on the inner periphery of the bolt 38. This facilitates the assembly of the cover 30 and improves the maintainability of the device case 40. Further, a second seal line 19 for sealing between the bottom surface 21B of the case body 20 and the upper cover 12 is provided on the outer periphery of the bolt 17 and the nut 18. Thus, even when the device case 40 is attached to the upper portion of the battery case 10, water can be prevented from entering the inside of the battery case 10.

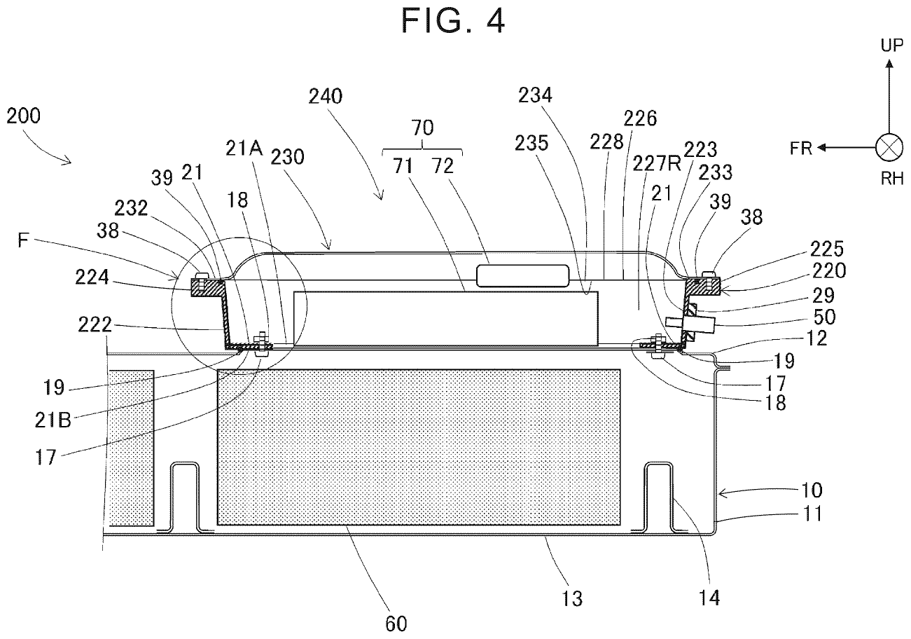

Next, with reference to FIG. 4, a comparative battery pack 200 will be described. The same parts as those of the battery pack 100 of the embodiment described above with reference to FIGS. 1 and 2 are denoted by the same reference numerals, and the description thereof will be omitted.

As illustrated in FIG. 4, the device case 240 of the battery pack 200 includes a case body 220 and a cover 230. The height of the front wall 222 of the case body 220 is the same height as the rear wall 223 to which the connector 50 is attached, the upper end of the left and right side wall 227L, 227R is not inclined with respect to the bottom surface 21B of the bottom plate 21, and is parallel to the bottom surface 21B of the bottom plate 21. The upper surface of the front flange 224, the upper surface of the rear flange 225, and the upper surfaces of the left and right side flanges 228 constitute a fastening surface 226 parallel to the bottom surface 21B of the bottom plate 21. Further, the lower surface of the front flange 232, the lower surface of the rear flange 233, and the lower surfaces of the left and right side flanges 234 of the cover 230 constitute a fastening surface 235 parallel to the bottom surface 21B of the bottom plate 21.

As described above, in the battery pack 200, the height of the front wall 222 of the case body 220 is the same as the height of the rear wall 223, and the fastening surfaces 226 and 235 of the case body 220 and the cover 230 are not inclined, and are parallel to the bottom surface 21B of the bottom plate 21.

Therefore, in the battery pack 200, the F portion in FIG. 4 protrudes upward and forward as compared with the battery pack 100, and the device case 240 is larger than the device case 40 of the battery pack 100.

On the other hand, in the battery pack 100, as shown in FIGS. 1 and 2, the height of the front wall 22 of the case body 20 is lower than the rear wall 23 to which the connector 50 is attached, and the fastening surfaces 26 and 35 of the case body 20 and the cover 30 are inclined downward toward the front. Therefore, the amount of upward and forward projection of the front portion of the device case 40 is smaller than the amount of projection of the device case 240 of the battery pack 200. Accordingly, the device case 40 of the battery pack 100 is smaller than the device case 240 of the battery pack 200, and the battery pack 100 is generally smaller than the battery pack 100. Therefore, the battery pack 100 can suppress interference with the body or the like as compared with the battery pack 200.

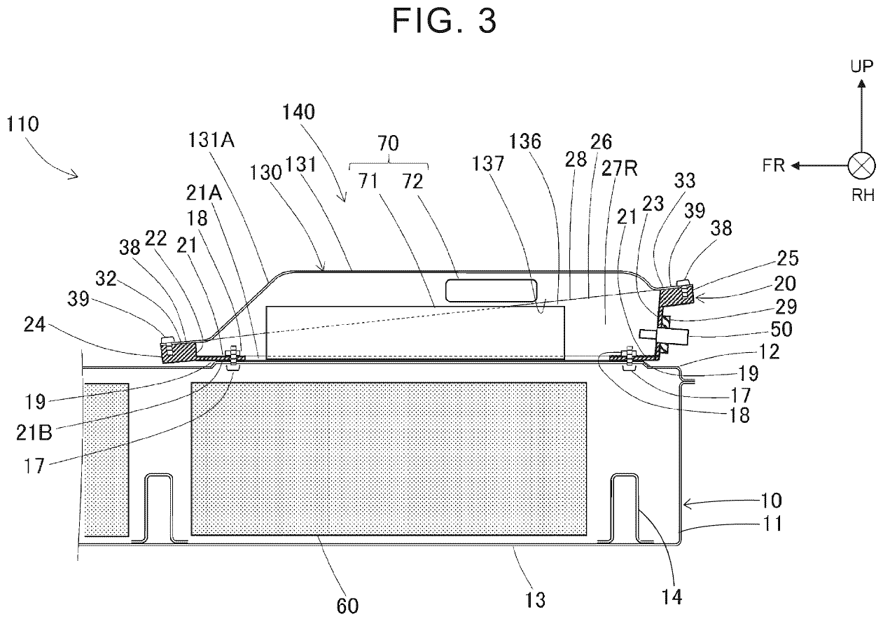

Next, a battery pack 110 according to another embodiment will be described with reference to FIG. 3. The battery pack 110 differs in that a cover 130 is provided instead of the cover 30 of the battery pack 100 described above with reference to FIGS. 1 and 2. Other configurations are the same as those of the battery pack 100 described above. Note that the same parts as those of the battery pack 100 are denoted by the same reference numerals, and description thereof will be omitted.

As illustrated in FIG. 3, the cover 130 is formed of an inclined surface such that the front portion 131A of the main body 131 follows a straight line connecting the respective corner portions of the junction box 71 and ECU 72. Therefore, the front portion 131A is lower in height than the front portion of the cover 30 of the battery pack 100. Other configurations are the same as those of the cover 30 described above.

In the battery pack 110, since the front portion 131A of the cover 130 is lower than the front portion of the cover 30, the amount of upward and forward projection of the front portion is smaller than that of the battery pack 100. This makes it possible to reduce the size of the device case 140, reduce the size of the battery pack 110, and further suppress interference with the body and the like.

What is claimed is:

1. A battery pack comprising:
a battery case that houses a battery; and
a device case that is attached to an upper portion of the battery case and houses an electric device for the battery, wherein
the device case includes a case body that houses a lower portion of the electric device, and a cover that is connected to an upper end of the case body and covers an upper portion of the electric device,
a connector connected to the electric device is provided on a first wall of the case body, and
a height of a second wall of the case body that faces the first wall is smaller than a height of the first wall.

2. The battery pack according to claim 1, wherein a fastening surface between the upper end of the case body and a lower end of the cover is inclined with respect to a bottom surface of the case body to decrease in height from the first wall toward the second wall.

3. The battery pack according to claim 2, wherein:
the upper end of the case body and the lower end of the cover are fastened by a first fastening member passing through the fastening surface, and a first seal line for sealing between the upper end of the case body and the lower end of the cover is provided on an inner periphery of the first fastening member; and
the case body is fastened to a ceiling plate of the battery case by a second fastening member, and a second seal line for sealing between the bottom surface of the case body and the ceiling plate of the battery case is provided on an outer periphery of the second fastening member.

4. A device case that houses an electric device, the device case comprising:
a case body that houses a lower portion of the electric device; and
a cover that is connected to an upper end of the case body and covers an upper portion of the electric device, wherein
a connector connected to the electric device is provided on a first wall of the case body, and
a height of a second wall of the case body that faces the first wall is smaller than a height of the first wall.

5. The device case according to claim 4, wherein:
a fastening surface between the upper end of the case body and a lower end of the cover is inclined with respect to a bottom surface of the case body to decrease in height from the first wall toward the second wall;
the upper end of the case body and the lower end of the cover are fastened by a fastening member passing through the fastening surface; and
a seal line for sealing between the upper end of the case body and the lower end of the cover is provided on an inner periphery of the fastening member.
